(19) United States
(12) Patent Application Publication
(10) Pub. No.: US 2026/0365325 A1
(43) Pub. Date: Nov. 19, 2026

(54) METHOD FOR PROVIDING INFORMATION TO AN OPERATOR FOR MANAGING AT LEAST ONE CUMULATIVE AGING PROCESS

(71) Applicant: SAFRAN HELICOPTER ENGINES, BORDES (FR)

(72) Inventors: Mathieu Louis Antoine GRISON, MOISSY-CRAMAYEL (FR); Vincent Thomas RETOIN, MOISSY-CRAMAYEL (FR); Estelle Marie Patricia CLARY, MOISSY-CRAMAYEL (FR); Eric Georges Michel TOQUOY, MOISSY-CRAMAYEL (FR)

(21) Appl. No.: 19/132,571

(22) PCT Filed: Nov. 22, 2023
(86) PCT No.: PCT/FR2023/051842

§ 371 Date: May 23, 2025

(30) Foreign Application Priority Data
Nov. 24, 2022 (FR) FR2212262

(51) Int. Cl. B64F 5/60; G07C 5/00; G07C 5/08

(52) U.S. Cl. CPC B64F 5/60; G07C 5/006; G07C 5/0808; G07C 5/0825

(57) ABSTRACT

A method of monitoring an aircraft is capable of providing information to an operator, for example a pilot, or to an automated system, for example an autopilot, to assist in managing, flight after flight, at least one cumulative aging process, for example creep, affecting at least part of a gas turbine of an aircraft of versatile use, for example a helicopter, in order to put it to make best use of it over the long term.

### TECHNICAL FIELD OF THE INVENTION

The invention relates to a method capable of providing information to an operator, for example a pilot, or to an automated system, for example an Autopilot, making it possible to help manage, flight after flight, at least one cumulative aging process, for example creep, of at least part of a gas turbine of an aircraft of versatile use, for example a helicopter, in order to make best use of it over the long term.

### STATE OF THE PRIOR ART

An aircraft pilot generally has access to flight information relating to the propulsion systems, displayed in the cockpit. This information refers in particular to certified limits (maximum limits not to be exceeded, required limits in the flight manual), these limits being managed by the pilot or managed by the computer.

Such limits include, for example, N1 (rotational speed of the gas generator at the high-pressure shaft), the T45H rated temperature of the high-pressure turbine, the power shaft torque, or an indicator combining these pieces of information. These limits constitute, for example, thresholds not to be exceeded in stabilized flight, and for which the maximum periods of continuous operation may be defined by regulations.

These indications do not take into account mission objectives, such as a quota, or the concept of acceptable cumulative aging. They are purely instantaneous and are not intended to prevent modes of cumulative aging that result in a need for a premature overhaul of the turbine engine, for example before its scheduled general overhaul.

In a context of uses that have little variability and are predictable, such as airliner missions, there are predictive methods that set binary indices for the throttle position, correctly matched to maintenance costs. These predictive methods most often also integrate maintenance costs and fuel consumption costs.

However, for versatile uses such as the varied missions of helicopters, the correspondence of a binary setpoint (whether torque, gas generator speed, or temperature) to costs is not reliable. Today, in this context, there is only ground-based monitoring of the meters, particularly with regard to creep, performed manually or with tools.

In this context, for these complex cumulative aging processes, such monitoring after the fact does not provide any useful forward-looking information for subsequent flights, and, in its current state, is not likely to help the pilot meet a cumulative goal during the flight, for example a goal set by a fleet manager.

Such monitoring or such indications also do not provide information that would enable the pilot to understand and develop an intuitive understanding of the actions to be taken in order to manage aging modes. Indeed, these aging phenomena involve multiple factors and are non-linear. Consequently, a pilot cannot develop reliable intuition about the conditions under which these aging modes accelerate or slow down, without additional guidance.

Cumulative aging is a form of damage that increases over time. Such aging certainly corresponds to the phenomenon of turbine blade creep, in the context of the intended application, but may also be oxidation, corrosion, or mechanical wear of parts (friction wear or bearing wear, for example).

Other types of aging may also occur, such as aging modes which are predominantly “cyclic”, relating to the number of times stress thresholds are crossed, both upwards and downwards (low-cycle fatigue (LCF), thermal cycling, number of starts/stops, etc.). However, it is difficult to take action on such cyclic aging, so these are not covered by this document.

### Presentation of the Invention

This document aims to address the aforementioned disadvantages.

To this end, this document proposes a method capable of providing information to an operator, for example a pilot, or to an automated system, concerning at least one cumulative aging process, for example creep, of at least part of a gas turbine of an aircraft during a mission of said aircraft, said method comprising a step of determining an aging progression score defined as follows:

$$SCORE = \{ \begin{matrix}0 if A ( t ) < S 1 \\ else = TERM 2 + TERM 2 + TERM 3 + TERM 4 + TERM 5\end{matrix}$$

the following being defined for this calculation:
   the mission quota,

$$Q = QFactor * \frac{S D}{D Q}$$

where.
   QFactor is a factor comprised for example between 0.1 and 10, to be made operator-modifiable if possible,
   SD is a major maintenance trigger threshold of an aging meter CV, in hours,
   DQ is the flight time between two overhauls of said part of the gas turbine or the target service life of said part of the gas turbine, in hours.
the default mission quota,

$${Q}_{DEF} = \frac{SD}{D Q}$$

the cumulative aging meter CV which is a value proportional to the cumulative aging,
the specified predicted flight duration of the mission in hours, M, for example between 0.2 and 3 hours,
the default predicted flight duration of the mission in hours, M_{DEF}, for example about 1 hour,
Y, a parameter to adapt to the application context, selected between M_{DEF}/2 and M_{DEF}
the cumulative flight duration of the mission, in hours, at a time t of the mission, T(t)
a first threshold S1, for example between 0.3 and 0.8, for example equal to 0.5,
a second threshold S2, for example between 3 and 10, for example equal to 5,
the mission start is defined by the flight start time t=t0
a time t=t1 of the end of a phase called the mission start phase is also defined such that:
   t1-t0 is greater than a duration of between 1 and 15 minutes, and/or
   t1 is the first time t greater than to for which the aircraft's flight speed is greater than a predetermined speed, for example 40 KTAS for a helicopter, and/or
   t1 is the first time t greater than to for which the aircraft's altitude with respect to the ground, also called ground clearance, is greater than a determined value, for example 500 feet,
a rolling time frame X, in seconds, for example between 10 and 30 seconds, for example about 20 seconds,
the moving average gradient over X seconds,

$$A ( t ) = \frac{CV ( t ) - CV ( t - X )}{Q * ( \frac{X}{3600} )}$$

the cumulative total per hour of flight since mission start (t0), at a time t of the mission, with no information on the predicted flight duration of the mission M,

$$B ( t ) = \frac{C V ( t ) - C V ( t 0 )}{Q * T ( t )}$$

the cumulative total per hour of flight since mission start, at a time t of the mission, anticipating a “typical short missions” flight duration of Y, in hours,

$$C ( t ) = \frac{C V ( t ) - C V ( t 0 )}{Q * max ( Y , T ( t ) )}$$

the cumulative total per hour of flight since mission start, at a time t of the mission, anticipating the specified predicted flight duration of the mission M,

$$D ( t ) = \frac{C V ( t ) - C V ( t 0 )}{Q * M}$$

$$TERM 1 = \{ \begin{matrix}1 & if A ( t ) > S 2 \\ else & 0\end{matrix} ,$$

$$TERM 2 = \{ \begin{matrix}\begin{matrix}2 if t > t 1 and M = MDEF and \\ Q = QDEF and D ( t ) > ( T ( t ) / M )\end{matrix} , \\ \begin{matrix}else 1 if t > t 1 and if trend of B ( t ) over \\ X seconds is monotonically increasing\end{matrix} , \\ else 0\end{matrix}$$

$$TERM 3 = \{ \begin{matrix}\begin{matrix}2 if t > t 1 and M = MDEF and \\ Q = QDEF and C ( t ) > 1\end{matrix} , \\ \begin{matrix}else 1 if t > t 1 and ( M \neq MDEF or \\ Q \neq QDEF ) and C ( t ) > 1\end{matrix} , \\ else 0\end{matrix}$$

$$TERM 4 = \{ \begin{matrix}\begin{matrix}1 if t > t 1 and ( M + MDEF or \\ Q \neq QDEF ) and D ( t ) > ( T ( t ) / M )\end{matrix} \\ else 0\end{matrix}$$

$$TERM 5 = \{ \begin{matrix}\begin{matrix}1 if t > t 1 and ( M \neq MDEF or \\ Q \neq QDEF ) and D ( t ) > 1\end{matrix} \\ else 0\end{matrix}$$

said method comprising a step of providing said information to the operator or to the automated system, dependent on said aging score.

The step of providing said information to an operator may be performed by displaying it.

As indicated above, the cumulative aging of part of a gas turbine is the damage to the part in question that increases over time. Such aging is primarily the phenomenon of creep, but may also be oxidation, corrosion, or mechanical wear of pieces of the part in question.

The cumulative aging meter CV is a value generally provided by the gas turbine computer and is proportional to the cumulative aging, measured or determined by calculation, based on values issued by sensors (gas generator rotation speed, temperature within the gas turbine, torque, outside temperature, deformation, etc.). The higher the CV value, the greater the cumulative aging of the pieces of the part in question or the module of the gas turbine.

An aircraft mission is defined as a succession of flight phases between the mission start and end. Typically, such a mission may include one or more takeoff and landing phases, and flight phases at varying speeds.

The major maintenance trigger threshold is a threshold predetermined by the gas turbine manufacturer, beyond which a large-scale maintenance operation, known as major maintenance, is necessary to ensure proper operation of the gas turbine or prevent premature damage. Such an operation generally requires the removal of the gas turbine.

The flight time between two major overhauls is known by the abbreviation TBO for “Time Between Overhaul.”

The target service life (DQ) may be a flight time greater than the time between two overhauls, for example twice the time between two overhauls.

The specified predicted flight duration of the mission M is a value determined before the mission start and entered into a computer of the aircraft, for example via an interface. This duration may be entered by an operator, such as a pilot.

The specified predicted flight duration of the mission, default or otherwise M_{DEF} or M, is for example between 0.2 and 3 hours. M_{DEF} is, for example, about 1.5 hours.

M will be set to the value of M_{DEF} if M is not entered by the operator.

The “typical short missions” flight duration Y will either be defined as fixed for a given application, for example, about 0.8 hours if M_{DEF}=1.5 hours, or determined by the application and calculated as an average of the flight durations of previous missions of the aircraft that were shorter than M_{DEF} and within the interval from M_{DEF}/2 to M_{DEF}.

Parameter Y may be adapted for example within this interval, according to the frequency of missions much shorter than M_{DEF}.

The cumulative flight duration of the mission at time t, T(t), is the time elapsed between mission start to and time t.

The moving value of CV over X seconds at time t is equal to the difference between the values of CV at time t and of CV at time t-X.

The calculation of some or all of these terms may be done in real time, at time periods of less than 1 second for example, about 500 ms for example.

Disabling the calculations of terms 2, 3, 4, and 5, i.e. setting these terms to 0, during the mission start phase (T(t)<t1), avoids distracting the operator, for example the pilot, by the appearance of indicators during the most complicated flight phases (takeoff, etc.).

Each term serves a different purpose and this therefore allows them to be combined.

When the engine load level at time t leads to minor aging (S1, defined by the engine manufacturer), the score is set to zero regardless of the value of the different terms. There is in fact no point in providing information, for example by displaying it, if the engine load no longer significantly changes the final total: there is no need to continue to encourage a lower load. This is an important element of the invention for avoiding solutions that are unnecessarily operationally limiting, since exceeding the quota does not carry any risk and subsequent 25 missions always offer possibilities for compensation.

The first term, TERM 1, alerts the operator of a very high load, with no obvious relationship to the indications of acceptable limits on engine speed. This is an initial sign for the operator that current flight conditions may lead to significant cumulative aging, and this can be displayed from the very beginning of the flight. This is also regular information that enhances the operator's intuitive perception of the situation.

The second term, TERM 2, can be used to increase the score if the load level at time t leads to an increase in aging that is not offset by the increase in the flight duration of the mission, versus the quota Q, or greater than a linear progression (if the M and Q values are not defined by the operator). This indication increases the score when, particularly at the beginning of the mission, the load occurs at a high cadence. This is an intermediate variant, between the gradient and the cumulative aging, that integrates any previous debits and credits and allows notification in the early part of the mission. It gradually loses relevance as the mission lengthens and then no longer contributes to the score, unless the exerted load remains truly excessive.

Instead of assigning a weight of 2 to TERM 2 (“option 1”) in the case where no effort is made to customize the objective of future missions (i.e. when neither the quota Q nor the flight duration of the mission M have been defined, for example by the operator), the weight can remain at 1, which leads to a maximum score that is below 5 (“option 2”).

The fourth term, TERM 3, allows increasing the score if the quota is exceeded by considering that the mission will last Y hours, and to lower the score back down if, after the flight duration Y has been exceeded, the cumulative total has converged back below the quota. This term allows for a first level of score progression (in absolute value) of the hourly cumulative total, avoiding an untimely score increase at the start of the mission if the minimum duration of Y hours was not used (which is why the absolute value of B(t) is not used).

Such a method may also provide pilot assistance and/or teach the operator about critical conditions leading to an aggravation of said cumulative aging.

Instead of assigning a weight of 2 to TERM 3 (“option 1”), in the case where no effort is made to customize the objective of future missions (i.e. when neither the quota Q nor the flight duration of the mission M have been defined, for example by the operator), the weight can remain at 1, which leads to a maximum score that is below 5 (“option 2”).

The terms TERM 4 and TERM 5 are disabled (equal to 0) when no effort is made to customize the objective of future missions (i.e. when neither the quota Q nor the flight duration of the mission M have been defined, for example by the operator). These terms may also be disabled for other reasons (desire for discreet displays and low usage, for example in a context of high mission variability).

The fifth term, TERM 4, allows the score to be increased if the cumulative total follows a progression toward the specified quota Q that is greater than a linear cumulative total, for the specified flight duration of the mission M. Since the beginning of the mission is generally more demanding, this allows increasing vigilance early on and fairly accurately, and allows indicating that moderation or pilot action is desirable.

The sixth term, TERM 5, allows the score to be increased by comparing the cumulative total to the quota Q, particularly in cases where it is not possible to remain within quota during the mission but it is still possible to limit the overrun.

It is also possible to freeze the score display during transient flight phases in which the pilot is otherwise occupied. Such a phase may be determined, in particular, by a significant variation in the moving average (for example, over a determined period) of the engine torque, that falls outside a limited range (for example, +/−5%) around the moving average. This allows the display to be frozen during such maneuvers.

It is also possible to display a warning light if A(t)<S1 (or some other value), for example a green warning light in the aircraft's engine limit display area (first limit indicator, N1 margin, T45H-defined above), this area being a priority area for the pilot's attention.

Three states of alert may be allowed in the “option 2” case:
no alert: no score indication
moderate alert: M=Mdef, Q-Qdef, the maximum score then being equal to 3, in the “option 2” case.
high alert: invited to enter M≠Mdef and M≠Mdef, the maximum score then being equal to 5.

Conversely, in the “option 1” case, the scale of 5 is preferred and it is the indication precision that is degraded, with scores that change by 2 points at a time for both TERM2 and TERM3.

It is also possible to manage multiple cumulative aging processes (e.g. both creep and corrosion at once, which are two different cumulative aging processes).

The calculated terms are relatively stable, but instabilities may exist. To compensate for such instabilities, it is possible to apply hysteresis to the score display. Some terms may have suitable hysteresis, for example greater than other terms.

The cumulative aging process may be creep, oxidation, and/or corrosion.

The method may be capable of providing information regarding at least two different cumulative aging processes. The individual score for each aging process is determined, and an overall score is calculated on the basis of these individual scores, for example in the form of an average or a weighted average. The information provided to the user is dependent on the overall score.

Whether or not t is outside the mission start phase may be determined by using the elapsed flight time since mission start, the aircraft's flight speed, and/or the aircraft's altitude with respect to the ground.

The level or amount of information provided to the operator may vary according to the aging score, the value of A(t), and/or the flight phase concerned.

The level of information may vary gradually, in increments, for example by displaying a value between 0 and 5 or by displaying a progress bar, or by not displaying such a value at all.

The amount of information may also vary by adding or removing information, so as to provide more or less detailed information depending on the situation.

In particular, it is possible that no information is provided (for example, not displayed) during certain critical flight phases, for example during the mission start phase, or if there is little aging (low score or A(t)). Increasingly complex information (different levels of information) may be provided or displayed depending on the flight phases, the aging, or at the operator's request.

In general, the invention proposes determining or calculating laws in real time and performing tests in real time based on these laws, leading to indications (displayable or not in the cockpit, at varying degrees of detail or depending on the flight phases), regardless of the aircraft and the installation (single- or multi-engine).

These indications are preferably not pointlessly disruptive, particularly during flight phases that require special attention from the pilot. (For example, they will be displayed so as to be visible during long phases-cruising or climbing (discreet flashing, for example)—and in a constant, non-distracting, or even disabled display (no flashing, etc.) during phases with significant power variations.)

These indications encourage and guide pilots to take action during long, stable flight phases, in order to manage, flight after flight, the cumulative aging of major propulsion system components. As indicated above, these indications may be adjusted according to the score or to the previous cumulative aging, depending on the mission types and business objectives, and on the operating context.

These indications must be progressive (multiple alert levels rather than a binary alert). Such progressiveness is particularly useful when aging is difficult to predict, the short-term consequences are minor, and the use of the aircraft is versatile, providing the pilot with an understanding of the flight conditions that produce cumulative aging (which is not intuitive with no such indications or with a binary indication).

Such indications, which allow identifying the phases that cause more or less pronounced cumulative aging, may also contribute to more environmentally friendly piloting decisions (CO2 emissions, etc.).

Unlike existing applications in contexts of non-versatile use, this score is not derived from an invariable cost calculation.

Here, a fleet manager wishing to make the best use of his gas turbines will be able, by monitoring trends after the fact, to modify the quota and the score setpoints to be adhered to by the pilot in order to manage a generally controlled path for the cumulative aging. This can be done by considering the full versatility of their priorities, the geographical operating context, seasonality, engine age, air intake protection requirements, and all other influencing factors, through a pragmatic method of learning and instructions using the scaling of the invention.

However, combining this indicator with indicators of fuel-efficient conditions is a logical association, for example adding a fuel economy score ranging from 0 to 2 depending on the deviation from the most fuel-efficient stable flight conditions.

The aircraft may be a rotary-wing aircraft, particularly a helicopter.

### BRIEF DESCRIPTION OF THE FIGURES

FIG. 1 is a diagram illustrating the evolution of the score over time during an aircraft mission, with no pilot action. This diagram also represents the evolution of the power, cumulative damage CV, temperature of the hot parts of the gas turbine, and altitude.

FIG. 2 is a diagram representing the evolution of the terms A(t), B(t), C(t), D(t), TERM 1, TERM 2, TERM 3, TERM 4, TERM 5, during the mission.

FIG. 3 is a diagram corresponding to FIG. 1 in which a pilot action allows reducing the score to 3,

FIG. 4 is a diagram corresponding to FIG. 1 in which a pilot action allows reducing the score to 2,

FIG. 5 is a diagram corresponding to FIG. 1 in which a pilot action allows reducing the score to 1.

### DETAILED DESCRIPTION OF THE INVENTION

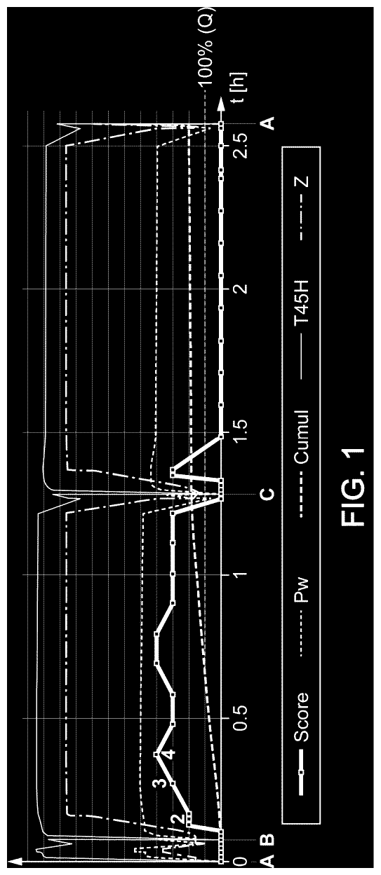

In the diagrams of FIGS. 1 to 5, the curves Score, Pw, Cumul, T45H, and Z respectively illustrate the evolution over time of the aging progression score, the output shaft power, the cumulative damage, the temperature of the hot parts of the gas turbine, and the altitude.

One will recall that the aging progression score can be defined as follows:

$$SCORE = \{ \begin{matrix}0 if A ( t ) < S 1 \\ else = TERM 2 + TERM 2 + TERM 3 + TERM 4 + TERM 5\end{matrix}$$

the following being defined for this calculation:
   the mission quota,

$$Q = QFactor * \frac{SD}{DQ}$$

where
   QFactor is a factor between 0.1 and 10 for example, to be made operator-modifiable if possible,
   SD is a major maintenance trigger threshold of an aging meter CV, in hours,
   DQ is the flight time between two overhauls of said part of the gas turbine or the target service life of said part of the gas turbine, in hours.
the default mission quota,

$${Q}_{DEF} = \frac{SD}{DQ}$$

the cumulative aging meter CV which is a value proportional to the cumulative aging
the specified predicted flight duration of the mission in hours, M, for example between 0.2 and 3 hours, to be made operator-modifiable if possible, the default predicted flight duration of the mission in hours, M_{DEF}, for example about 1 hour,
Y, a parameter to adapt to the application context, selected between M_{DEF}/2 and M_{DEF}
the cumulative flight duration of the mission, in hours, at a time t of the mission, T(t)
a first threshold S1, for example between 0.3 and 0.8, for example equal to 0.5,
a second threshold S2, for example between 3 and 10, for example equal to 5,
the mission start is defined by the flight start time t=t0
a time t=t1 of the end of a phase called the mission start phase is also defined such that:
   t1-t0 is greater than a duration of between 1 and 15 minutes, and/or
   t1 is the first time t greater than to for which the aircraft's flight speed is greater than a predetermined speed, for example 40 KTAS for a helicopter, and/or
   t1 is the first time t greater than to for which the aircraft's altitude with respect to the ground, also called ground clearance, is greater than a determined value, for example 500 feet,
a rolling time frame X, in seconds, for example between 10 and 30 seconds, for example about 20 seconds,
the moving average gradient over X seconds,

$$A ( t ) = \frac{CV ( t ) - CV ( t - X )}{Q * ( \frac{X}{3600} )}$$

the cumulative total per hour of flight since mission start (t0), at a time t of the mission, with no information on the predicted flight duration of the mission M,

$$B ( t ) = \frac{CV ( t ) - CV ( t 0 )}{Q * T ( t )}$$

the cumulative total per hour of flight since mission start, at a time t of the mission, anticipating a “typical short missions” flight duration of Y, in hours,

$$C ( t ) = \frac{CV ( t ) - CV ( t 0 )}{Q * max ( Y , T ( t ) )}$$

the cumulative total per hour of flight since mission start, at a time t of the mission, anticipating the specified predicted flight duration of the mission M,

$$D ( t ) = \frac{CV ( t ) - CV ( t 0 )}{Q * M}$$

$$- TERM 1 = \{ \begin{matrix}1 & if A ( t ) > S 2 \\ else & 0\end{matrix} ,$$

$$- TERM 2 = \{ \begin{matrix}2 & if t > t 1 and M = MDEF and Q = QDEF and D ( t ) > T ( t ) / M ) , \\ else 1 & if t > t 1 and if trend of B ( t ) over X seconds is monotonically increasing , \\ else & 0\end{matrix}$$

$$- TERM 3 = \{ \begin{matrix}2 & if t > t 1 and M = MDEF and Q = QDEF and C ( t ) > 1 , \\ else 1 & if t > t 1 and ( M \neq MDEF or Q \neq QDEF ) and C ( t ) > 1 , \\ else & 0\end{matrix}$$

$$- TERM 4 = \{ \begin{matrix}1 & if t > t 1 and ( M \neq MDEF or Q \neq QDEF ) and D ( t ) > T ( t ) / M \\ else & 0\end{matrix}$$

$$- TERM 5 = \{ \begin{matrix}1 & if t > t 1 and ( M \neq MDEF or Q \neq QDEF ) and D ( t ) > 1 \\ else & 0\end{matrix} .$$

The mission illustrated in FIGS. 1 to 5 is the case of a helicopter mission:
taking off from point A (time=0),
moving to point B and landing at point B;
taking off from point B, moving to point C and landing at point C;
taking off from point C, moving back to point A and landing at point A.

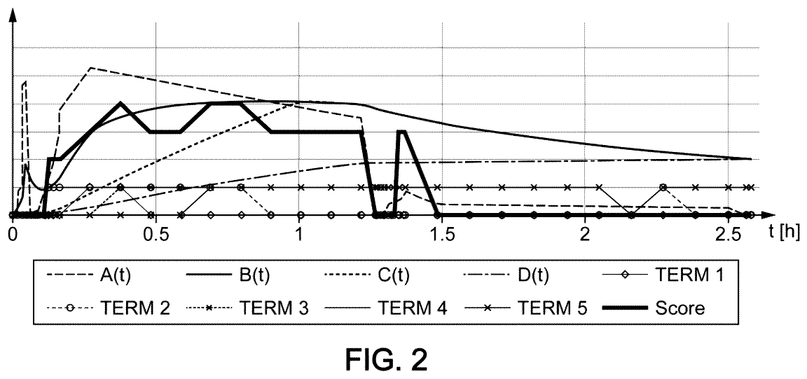

One can see in the diagram in FIG. 1 that the score (here the creep score, calculated using the formula described above which sums the terms TERM 1 to TERM 6, the evolution shown in FIG. 2) reaches a maximum of 4. In such a case, the quota Q at the end of the mission reaches twice the desired quota and therefore significantly exceeds this desired quota.

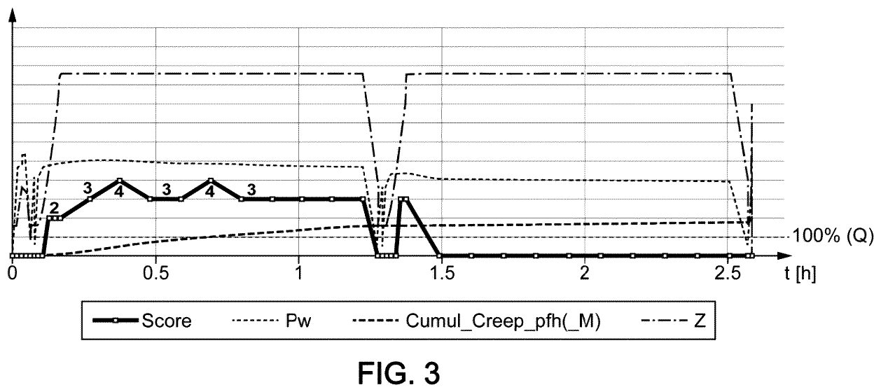

The diagram in FIG. 3 illustrates the case where, during the same mission, the pilot takes actions that reduce the score to 3. In the case illustrated in FIG. 3, an action is taken by the pilot each time the score reaches a value of 4. Thus, the pilot reduces the horizontal movement speed by 1 KTAS a first time, and then a second time later on. In such a case, the quota Q at the end of the mission reaches 1.8 times the desired quota. The mission was also extended by 30 seconds compared to the case illustrated in FIG. 1.

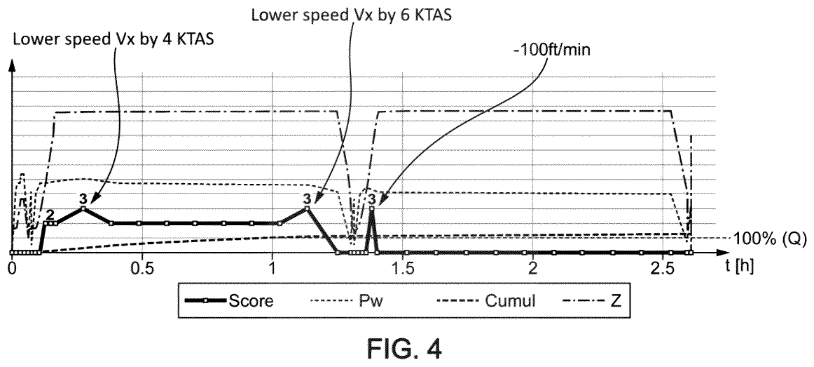

The diagram in FIG. 4 illustrates the case where, during the same mission, the pilot takes actions that reduce the score to 2. In the case illustrated in FIG. 4, an action is taken by the pilot each time the score reaches a value of 3. Thus, the pilot reduces the horizontal speed by 4 KTAS a first time, reduces this speed again by 6 KTAS later on, and then lowers the vertical speed by 100 feet per minute at the end of the climb. In such a case, the quota Q at the end of the mission reaches 1.2 times the desired quota. The mission was also extended by 2 minutes compared to the case illustrated in FIG. 1.

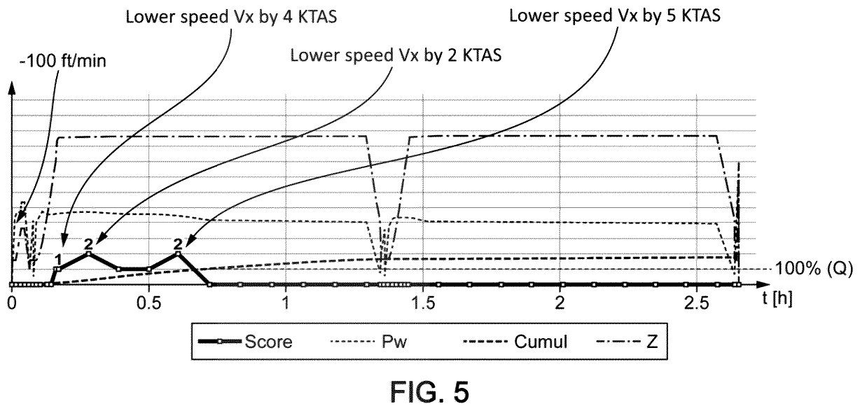

The diagram in FIG. 5 illustrates the case where, during the same mission, the pilot takes actions to reduce the score to 1. In the case illustrated in FIG. 5, an action is taken by the pilot each time the score reaches a value of 2. Thus, the pilot first reduces the vertical speed by 100 feet per minute, then reduces the horizontal speed by 4 KTAS, reduces this speed again by 2 KTAS later on, and then lowers this speed again by 5 KTAS later on. In such a case, the quota Q at the end of the mission reaches 0.7 times the desired quota. The mission was also extended by 4.6 minutes compared to the case illustrated in FIG. 1. It can be seen that this extension is relatively small compared to the total flight duration of the mission.

Depending on constraints concerning the duration of the mission, and depending on the instructions of a fleet manager, the pilot (directly or via an autopilot) will be able to choose the score 4, 3, or 2 or 1 to aim for, with the assurance of applying to the flight only those strict limitations which allow the pilot to draw closer to the quota.

1. A method capable of providing information to an operator or to an automated system, concerning at least one cumulative aging process of at least part of a gas turbine of an aircraft during a mission of said aircraft, said method comprising a step of determining an aging progression score defined as follows:
$$SCORE = \{ \begin{matrix}0 if A ( t ) < S 1 \\ else = TERM 1 + TERM 2 + TERM 3 + TERM 4 + TERM 5\end{matrix}$$
the following being defined for this calculation:
the mission quota,
$$Q = QFactor * \frac{SD}{DQ}$$
where
QFactor is a factor,
SD is a major maintenance trigger threshold of an aging meter CV, in hours,
DQ is the flight time between two overhauls of said part of the gas turbine or the target service life of said part of the gas turbine, in hours;
the default mission quota,
$${Q}_{DEF} = \frac{SD}{DQ}$$
the cumulative aging meter CV which is a value proportional to the cumulative aging,
the specified predicted flight duration of the mission in hours, M,
the default predicted flight duration of the mission in hours, M_{DEF},
Y, a parameter to adapt to the application context, selected between M_{DEF}/2 and M_{DEF}
the cumulative flight duration of the mission, in hours, at a time t of the mission, T(t)
a first threshold S1, for example between 0.3 and 0.8, for example equal to 0.5,
a second threshold S2, for example between 3 and 10, for example equal to 5,
the mission start is defined by the flight start time t=t0
a time t=t1 of the end of a phase called the mission start phase is also defined such that:
t1-t0 is greater than a duration of between 1 and 15 minutes, and/or
t1 is the first time t greater than t0 for which the aircraft's flight speed is greater than a predetermined speed, and/or
t1 is the first time t greater than to for which the aircraft's altitude with respect to the ground, also called ground clearance, is greater than a determined value, for example 500 feet,
a rolling time frame X in seconds,
the moving average gradient over X seconds,
$$A ( t ) = \frac{CV ( t ) - CV ( t - X )}{Q * ( \frac{x}{3600} )}$$
the cumulative total per hour of flight since mission start (t0), at a time t of the mission, with no information on the predicted flight duration of the mission M,
$$B ( t ) = \frac{CV ( t ) - CV ( t 0 )}{Q * T ( t )}$$
the cumulative total per hour of flight since mission start, at a time t of the mission, anticipating a “typical short missions” flight duration of Y, in hours,
$$C ( t ) = \frac{CV ( t ) - CV ( t 0 )}{Q * max ( Y , T ( t ) )}$$
the cumulative total per hour of flight since mission start, at a time t of the mission, anticipating the specified predicted flight duration of the mission M,
$$D ( t ) = \frac{CV ( t ) - CV ( t 0 )}{Q * M}$$
$$TERM 1 = \{ \begin{matrix}1 & if A ( t ) > S 2 \\ else & 0\end{matrix} ,$$
$$TERM 2 = \{ \begin{matrix}2 & if t > t 1 and M = MDEF and Q = QDEF and D ( t ) > T ( t ) / M ) , \\ else 1 & if t > t 1 and if trend of B ( t ) over X seconds is monotonically increasing , \\ else & 0\end{matrix}$$
$$TERM 3 = \{ \begin{matrix}2 & if t > t 1 and M = MDEF and Q = QDEF and C ( t ) > 1 , \\ else 1 & if t > t 1 and ( M \neq MDEF or Q \neq QDEF ) and C ( t ) > 1 , \\ else & 0\end{matrix}$$
$$TERM 4 = \{ \begin{matrix}1 & if t > t 1 and ( M \neq MDEF or Q \neq QDEF ) and D ( t ) > T ( t ) / M \\ else & 0\end{matrix}$$
$$TERM 5 = \{ \begin{matrix}1 & if t > t 1 and ( M \neq MDEF or Q \neq QDEF ) and D ( t ) > 1 \\ else & 0\end{matrix}$$
said method comprising a step of providing said information to the operator or to the automated system, dependent on said aging progression score.

2. The method according to claim 1, wherein the cumulative aging is creep, oxidation, and/or corrosion.

3. The method according to claim 1, wherein said method is capable of providing information regarding at least two different cumulative aging processes, the individual score for each aging process being determined and an overall score being calculated on the basis of said individual scores, the information provided to the user being dependent on said overall score.

4. The method according to claim 1, wherein it is determined whether or not it is outside the mission start phase by using an elapsed flight time since mission start, the flight speed of the aircraft, and/or the altitude of the aircraft with respect to the ground.

5. The method according to claim 1, wherein the level or amount of information provided to the operator varies according to the aging score, the value of A(t), and/or the flight phase concerned.

6. The method according to claim 1, wherein the aircraft is a rotary-wing aircraft.

7. The method according to claim 1, wherein said at least one cumulative aging process comprises creep.

8. The method according to claim 1, wherein QFactor is comprised between 0.1 and 10.

9. The method according to claim 1, wherein QFactor is operator-modifiable.

10. The method according to claim 1, wherein M is comprised between 0.2 and 3 hours.

11. The method according to claim 1, wherein M_{DEF} is equal about 1 hour.

12. The method according to claim 1, wherein S1 is comprised between 0.3 and 0.8.

13. The method according to claim 1, wherein S2 is comprised between 3 and 10.

14. The method according to claim 1, wherein X is comprised between 10 and 30 seconds.

15. The method according to claim 1, wherein the aircraft is an helicopter, and a predetermined speed is 40 KTAS.

16. The method according to claim 1, wherein the determined value is 500 feet.

17. The method according to claim 1, wherein the operator is a pilot.

18. The method according to claim 1, wherein the overall score is in the form of an average or a weighted average.
